(19) United States
(12) Patent Application Publication
(10) Pub. No.: US 2026/0163668 A1
(43) Pub. Date: Jun. 11, 2026

(54) UNMANNED AERIAL VEHICLE (UAV) INTERFERENCE SYSTEM, UAV INTERFERENCE METHOD AND ELECTRONIC DEVICE WITH UAV INTERFERENCE INDICATION FUNCTION

(71) Applicant: IWAVENOLOGY Co., Ltd., Kaohsiung City (TW)

(72) Inventors: Tsu-Yu LO, Kaohsiung City (TW); Je-Yao CHANG, Kaohsiung City (TW); Zhi-Wei TAN, Kaohsiung City (TW); Pin-Yen CHEN, Kaohsiung City (TW); Shih-Ping HUANG, Kaohsiung City (TW); Wei-Ting TSAI, Kaohsiung City (TW); Chong-Yi LIOU, Kaohsiung City (TW)

(73) Assignee: IWAVENOLOGY Co., Ltd., Kaohsiung City (TW)

(21) Appl. No.: 18/982,154

(22) Filed: Dec. 16, 2024

(30) Foreign Application Priority Data
Dec. 15, 2023 (TW) 112213734

(51) Int. Cl. H04K 3/00

(52) U.S. Cl. CPC H04K 3/90

(57) ABSTRACT

An unmanned aerial vehicle (UAV) interference system including an electronic device and an UAV jammer is disclosed. The electronic device is configured to obtain a first position information related to an UAV in a space and generate an indication information based on the first position information and a second position information related to the electronic device in the space. The UAV jammer is disposed corresponding to the electronic device and a state of the UAV jammer is adjusted according to the indication information to allow the UAV jammer to selectively emit an interference signal.

### TECHNICAL FIELD

The invention relates to an unmanned aerial vehicle (UAV), and more particularly to an UAV interference system, an UAV interference method and an electronic device with an UAV interference indication function.

### BACKGROUND

In general, when a user wants to use an UAV jammer to emit interference signals to an UAV flying in the sky, he or she often needs to adjust the launch angle of the UAV jammer through visual aiming, so that the interference signals emitted by the UAV jammer can be accurately directed to the UAV in the sky.

However, since the UAV flying in the sky is too far away from the user and the UAV continues to fly rapidly, and affected by external environmental factors such as sunlight, rain, and sandstorms outdoors, it will prevent the user from successfully operating the UAV jammer to accurately emit the interference signals to the UAV in the sky, thus resulting in the failure to successfully complete the task of jamming the UAV.

Therefore, the above-mentioned problems encountered by the prior art still need to be solved.

### SUMMARY

In view of this, an UAV interference system, an UAV interference method and an electronic device with an UAV interference indication function are proposed in the invention to effectively solve the above-mentioned problems in the prior art.

An embodiment of the invention is an UAV interference system. In this embodiment, the UAV interference system includes an electronic device and an UAV jammer. The electronic device is configured to obtain first position information of an UAV in a three-dimensional space and generate indication information based on the first position information and second position information of the electronic device. The UAV jammer operatively associated with the electronic device, wherein the UAV jammer is configured to adjust its operational state based on the indication information and selectively emit an interference signal toward the UAV.

In an embodiment, the first position information includes at least a coordinate value, a horizontal angle, and a vertical angle of the UAV, and the second position information includes a coordinate value, a horizontal angle, and a vertical angle of the electronic device.

In an embodiment, the indication information includes a relative distance derived from the first and second coordinate values, horizontal angle adjustment information derived from the first and second horizontal angles, and vertical angle adjustment information derived from the first and second vertical angles.

In an embodiment, the indication information further includes one or more indicators for: identifying the real-time location of the UAV, and specifying horizontal and vertical movement directions required to align the UAV jammer with the UAV.

In an embodiment, the operational state of the UAV jammer includes a launch angle, and the launch angle is dynamically adjusted to target the UAV based on the indication information.

In an embodiment, the electronic device is further configured to display an electronic map illustrating the locations of the UAV and the electronic device based on the position information

In an embodiment, the electronic device calculates an optimal trajectory between the UAV and the electronic device and marks the trajectory on the electronic map.

In an embodiment, the electronic device is physically integrated with the UAV jammer or mounted on a bracket operatively associated with the UAV jammer.

In an embodiment, the electronic device is a mobile device selected from a group consisting of a mobile phone, a tablet computer, or a personal digital assistant (PDA).

Another embodiment of the invention is an electronic device with an UAV interference indication function. In this embodiment, the electronic device includes an obtaining module, a generation module and a display module. The obtaining module is configured to configured to obtain first position information of a UAV in a three-dimensional space and second position information of the electronic device. The generation module is coupled to the obtaining module and configured to generate indication information based on the first position information and the second position information. The display module is coupled to the generation module and configured to display the indication information, wherein an operational state of an UAV jammer operatively associated with the electronic device is adjusted based on the indication information and the UAV jammer selectively emits an interference signal toward the UAV.

Another embodiment of the invention is an UAV interference method. In this embodiment, the UAV interference method is applied to an UAV interference system. The UAV interference system includes an electronic device and an UAV jammer. The UAV jammer is operatively associated with the electronic device. The UAV interference method includes steps of: the electronic device obtaining first position information of a UAV in a three-dimensional space; the electronic device generating an indication information based on the first position information and second position information of the electronic device; and the UAV jammer adjusting its operational state based on the indication information and selectively emit an interference signal toward the UAV.

Compared with the prior art, the invention proposes an UAV interference system, an UAV interference method and an electronic device with an UAV interference indication function, which can effectively generate the indication information based on the position information of one or more UAVs to guide the user to correctly operate and adjust the state of the UAV jammer. Even if the UAV is too far away and flying too fast or affected by external environmental factors such as sunlight, rain, wind and sand, the user can still smoothly operate the UAV jammer according to the instruction information provided by the electronic device to accurately emit the interference signal to the UAV to successfully complete the task of jamming the UAV.

To further understand the features and technical contents of the invention, please refer to the following detailed description and drawings of the invention. However, the drawings provided are only for reference and explanation, and are not intended to limit the invention.

### BRIEF DESCRIPTION OF THE DRAWINGS

FIG. 1 illustrates a schematic diagram of an UAV interference system in an embodiment of the invention.

FIG. 2 illustrates an embodiment that the user operates the UAV jammer according to the indication information displayed on the electronic device to emit the interference signal.

FIG. 3 illustrates a schematic diagram of an UAV interference system in another embodiment of the invention.

FIG. 4 illustrates an embodiment that the user operates the UAV jammer according to the indication information displayed on the electronic device to emit the interference signal.

FIG. 5A to FIG. 7B illustrate different embodiments of the indication information displayed on the display interface of the electronic device respectively.

FIG. 8 to FIG. 9 illustrate different embodiments of the electronic maps displayed by the electronic device respectively.

FIG. 10 illustrates a schematic diagram of an electronic device with an UAV interference indication function in another embodiment of the invention.

FIG. 11 illustrates a flowchart of an UAV interference method used in the UAV interference system of the invention.

### DETAILED DESCRIPTION

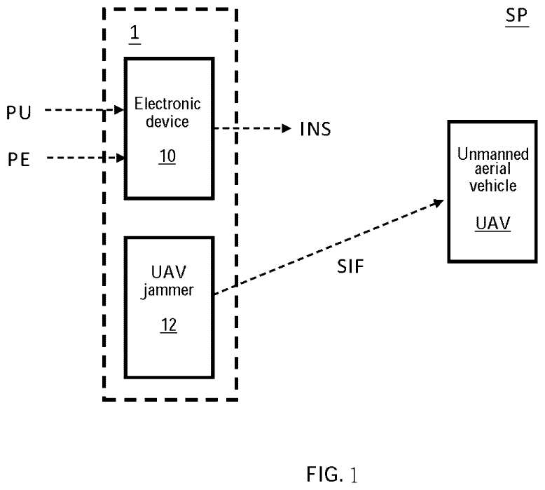

The following illustrates implementations disclosed by the invention through specific embodiments and in conjunction with FIG. 1 to FIG. 11, and those skilled in the art can understand the advantages and effects of the invention from the contents disclosed in this specification. However, the contents disclosed below are not intended to limit the scope of protection of the invention, and those skilled in the art may implement the invention with other different embodiments based on different viewpoints and applications without departing from the spirit of the conception of the invention.

For the sake of clarity, the drawings of the invention are all simplified schematic diagrams for illustrating the basic structure of the invention. Therefore, the structure illustrated in the drawings of the invention is not drawn to scale according to the shape and size of the structure in actual implementations. For example, the size of a specific component is enlarged for ease of illustration.

Unless otherwise defined, all terms (including technical and scientific terms) used herein have the same meaning as understood by those having ordinary skills in the art to which the invention belongs. It will be further understood that the terms such as those defined in commonly used dictionaries should be interpreted as having meanings consistent with their meanings in the related art and the context of the invention, and are not to be interpreted as having idealized or overly formal meanings, unless explicitly defined herein.

A preferred specific embodiment of the invention is an unmanned aerial vehicle (UAV) interference system. Please refer to FIG. 1. FIG. 1 illustrates a schematic diagram of the UAV interference system in this embodiment. As shown in FIG. 1, the UAV interference system 1 includes an electronic device 10 and an UAV jammer 12. In practical applications, the electronic device can be a handheld or portable electronic device, such as a mobile phone, a tablet computer or a personal digital assistant (PDA), but not limited to this.

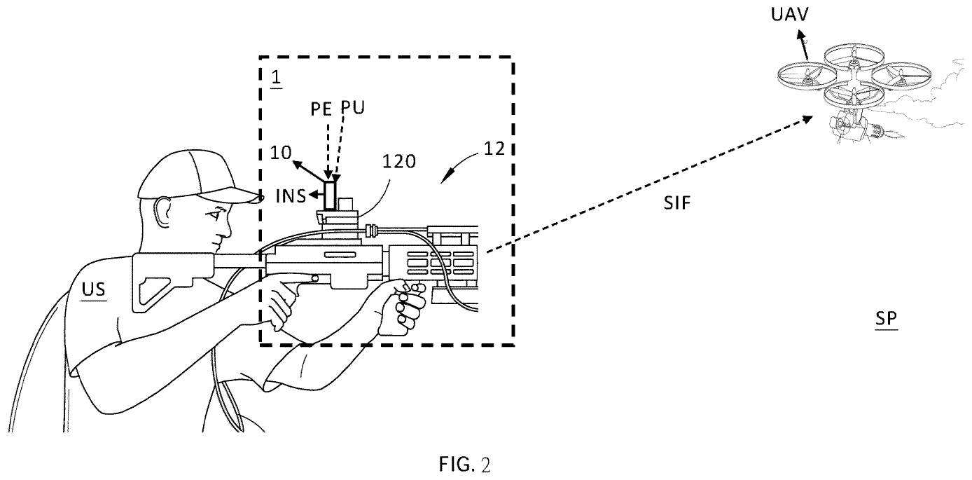

It should be noted that the electronic device 10 and the UAV jammer 12 can be disposed corresponding to each other. For example, the UAV jammer 12 in FIG. 2 can have a bracket 120 and the electronic device 10 can be disposed on the bracket 120, or the electronic device 10 can also be directly integrated into the UAV jammer 12, but not limited to this.

In this embodiment, the electronic device 10 is configured to obtain a first position information PU related to an unmanned aerial vehicle UAV in a space SP and a second position information PE related to the electronic device 10 itself in the space SP respectively, and generate an indication information INS according to the first position information PU and the second position information PE.

It should be noted that the electronic device 10 can obtain the positioning information such as the first position information PU and the second position information PE from an external system such as Global Positioning System (GPS), but not limited to this; the first position information PU can include a first coordinate value, a first horizontal angle and a first vertical angle of the unmanned aerial vehicle UAV in the space SP; the second position information PE can include a second coordinate value, a second horizontal angle and a second vertical angle of the electronic device 10 itself in the space SP, but not limited to this.

As for the indication information INS, it can include a relative distance value obtained according to the first coordinate value of the unmanned aerial vehicle UAV in the space SP and the second coordinate value of the electronic device 10 in the space SP, a horizontal angle indication information obtained according to the first horizontal angle of the unmanned aerial vehicle UAV in the space SP and the second horizontal angle of the electronic device 10 in the space SP, and a vertical angle indication information obtained according to the first vertical angle of the unmanned aerial vehicle UAV in the space SP and the second vertical angle of the electronic device 10 in the space SP, but not limited to this.

In detail, the horizontal angle indication information can include a horizontal arrow indicating a horizontal movement direction from the second horizontal angle of the electronic device 10 in the space SP to the first horizontal angle of the unmanned aerial vehicle UAV in the space SP and the vertical angle indication information can include a vertical arrow indicating a vertical movement direction from the second vertical angle of the electronic device 10 in the space SP to the first vertical angle of the unmanned aerial vehicle UAV in the space SP, but not limited to this.

As shown in FIG. 2, when the electronic device 10 displays the indication information INS, the user US can adjust a state of the UAV jammer 12 according to the indication information INS to allow the UAV jammer 12 to selectively emit an interference signal SIF. For example, the user US can adjust a launch angle of the UAV jammer 12 according to the horizontal angle indication information and the vertical angle indication information in the indication information INS displayed by the electronic device 10 to allow the UAV jammer 12 to aim at the unmanned aerial vehicle UAV, so that the interference signal SIF emitted by the UAV jammer 12 can be accurately shot to the unmanned aerial vehicle UAV, thereby successfully achieving the effect of jamming the unmanned aerial vehicle UAV.

It should be noted that although the appearance of the UAV jammer 12 shown in FIG. 2 adopts a gun-type structure, in fact, the appearance of the UAV jammer 12 can also adopt other different structures depending on actual needs or application scenarios, such as handheld structure, vehicle-mounted structure, fixed structure, etc., without specific restrictions.

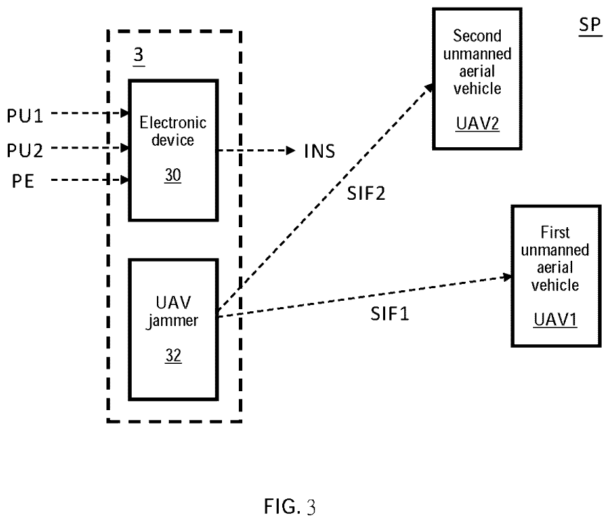

In another preferred embodiment, please refer to FIG. 3. The UAV interference system 3 includes an electronic device 30 and a UAV jammer 32. In practical applications, the electronic device can be a handheld or portable electronic device, such as a mobile phone, a tablet computer or a PDA, but not limited to this.

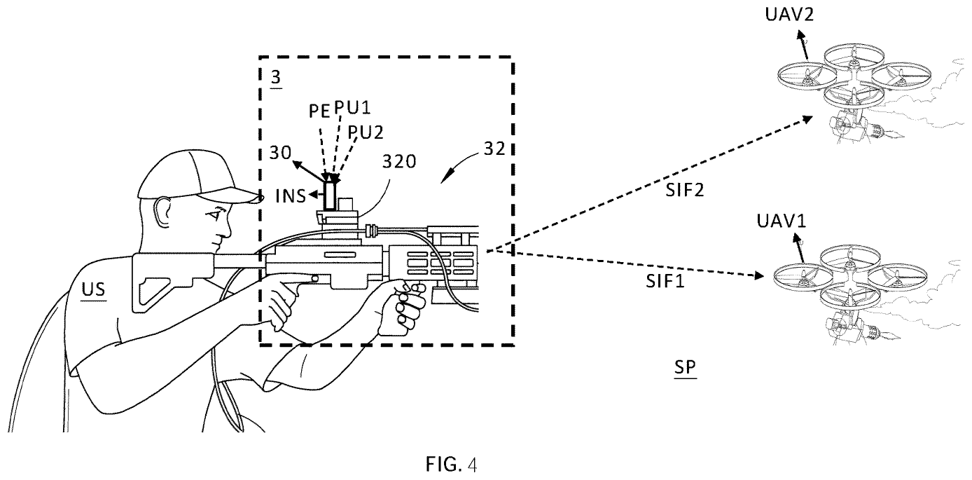

It should be noted that the electronic device 30 and the UAV jammer 32 can be disposed corresponding to each other. For example, the UAV jammer 32 in FIG. 4 can have a bracket 320 and the electronic device 30 can be disposed on the bracket 320 or the electronic device 30 can also be integrated inside the UAV jammer 32, but not limited to this.

In this embodiment, the electronic device 30 is configured to obtain a first position information PU1 related to a first unmanned aerial vehicle UAV1 in a space SP, a second position information PE related to the electronic device 30 itself in the space SP and a third position information PU2 related to the second unmanned aerial vehicle UAV2 in the space SP respectively, and generate an indication information INS based on the first position information PU1, the second position information PE and the third position information PU2.

It should be noted that the first position information PU1 can include a first coordinate value, a first horizontal angle and a first vertical angle of the first unmanned aerial vehicle UAV1 in the space SP, but not limited to this; the second position information PE can include a second coordinate value, a second horizontal angle and a second vertical angle of the electronic device 10 itself in the space SP, but not limited to this; the third position information PU2 can include a third coordinate value, a third horizontal angle and a third vertical angle of the second unmanned aerial vehicle UAV2 in the space SP, but not limited to this.

The indication information INS can include a first relative distance value between the first unmanned aerial vehicle UAV1 and the electronic device 30 in the space SP obtained according to the first coordinate value of the first unmanned aerial vehicle UAV1 in the space SP and the second coordinate value of the electronic device 30 in the space SP, a first horizontal angle indication information obtained according to the first horizontal angle of the first unmanned aerial vehicle UAV1 in the space SP and the second horizontal angle of the electronic device 30 in the space SP, and a first vertical angle indication information obtained according to the first vertical angle of the first unmanned aerial vehicle UAV1 in the space SP and the second vertical angle of the electronic device 30 in the space SP, but not limited to this.

Similarly, the indication information INS can also include a second relative distance value between the second unmanned aerial vehicle UAV2 and the electronic device 30 in the space SP obtained according to the third coordinate value of the second unmanned aerial vehicle UAV2 in the space SP and the second coordinate value of the electronic device 30 in the space SP, a second horizontal angle indication information obtained according to the third horizontal angle of the second unmanned aerial vehicle UAV2 in the space SP and the second horizontal angle of the electronic device 30 in the space SP, and a second vertical angle indication information obtained according to the third vertical angle of the second unmanned aerial vehicle UAV2 in the space SP and the second vertical angle of the electronic device 30 in the space SP, but not limited to this.

In detail, the first horizontal angle indication information can include a horizontal arrow indicating a horizontal movement direction from the second horizontal angle of the electronic device 30 in the space SP to the first horizontal angle of the first unmanned aerial vehicle UAV1 in the space SP and the first vertical angle indication information can include a vertical arrow indicating a vertical movement direction from the second vertical angle of the electronic device 30 in the space SP to the first vertical angle of the first unmanned aerial vehicle UAV1 in the space SP, but not limited to this.

Similarly, the second horizontal angle indication information can include a horizontal arrow indicating a horizontal movement direction from the second horizontal angle of the electronic device 30 in the space SP to the third horizontal angle of the second unmanned aerial vehicle UAV2 in the space SP and the second vertical angle indication information can include a vertical arrow indicating a vertical movement direction from the second vertical angle of the electronic device 30 in the space SP to the third vertical angle of the second unmanned aerial vehicle UAV2 in the space SP, but not limited to this.

As shown in FIG. 4, when the electronic device 30 displays the indication information INS, the user US can adjust the state of the UAV jammer 32 according to the indication information INS to allow the UAV jammer 32 to selectively emit interference signals SIF1˜SIF2.

For example, the user US can adjust a launch angle of the UAV jammer 32 according to the first horizontal angle indication information and the first vertical angle indication information in the indication information INS displayed by the electronic device 30 so that the UAV jammer 32 can aim at the first unmanned aerial vehicle UAV1, and the interference signal SIF1 emitted by the UAV jammer 32 can be accurately shot to the first unmanned aerial vehicle UAV1, thereby successfully achieving the effect of jamming the first unmanned aerial vehicle UAV1.

Similarly, the user US can also adjust the launch angle of the UAV jammer 32 according to the second horizontal angle indication information and the second vertical angle indication information in the indication information INS displayed by the electronic device 30 so that the UAV jammer 32 can aim at the second unmanned aerial vehicle UAV2, and the interference signal SIF2 emitted by the UAV jammer 32 can be accurately shot to the second unmanned aerial vehicle UAV2, thereby successfully achieving the effect of jamming the second unmanned aerial vehicle UAV2.

It should be noted that although the appearance of the UAV jammer 32 shown in FIG. 4 adopts a gun-shaped structure, in fact, the appearance of the UAV jammer 32 can also adopt other different structures depending on actual needs or application scenarios, such as handheld structure, vehicle-mounted structure, fixed structure, etc., without specific restrictions.

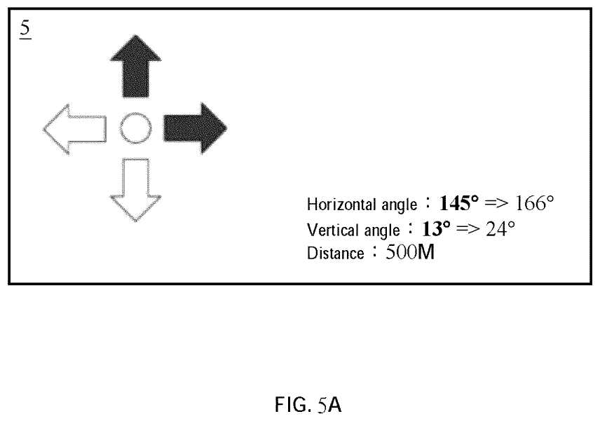

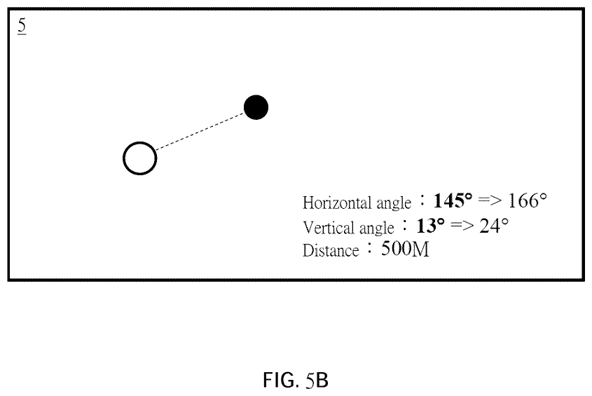

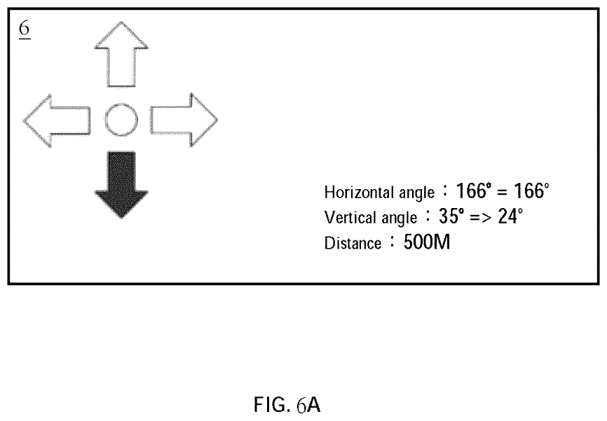

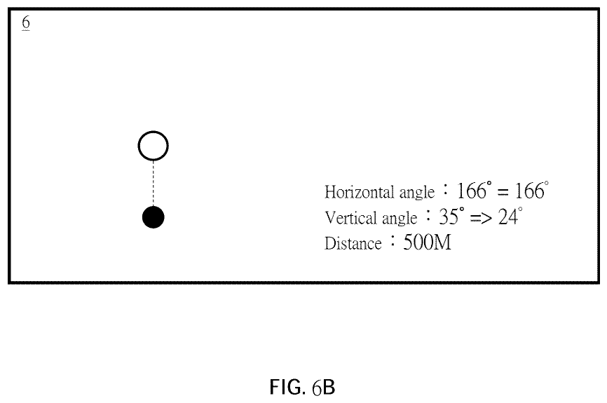

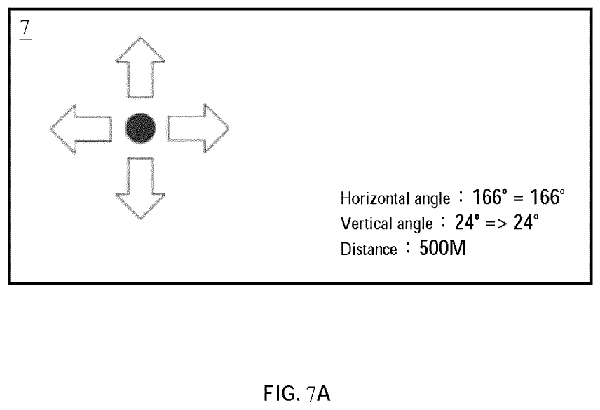

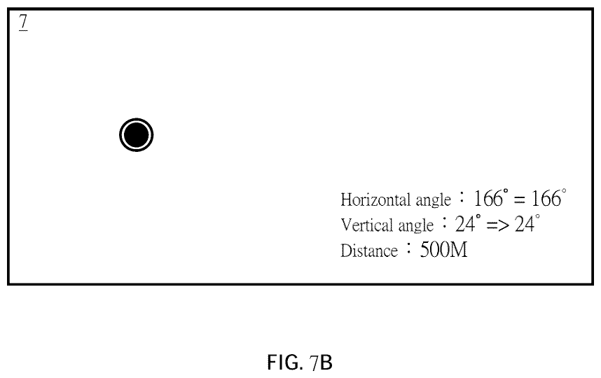

Next, please refer to FIG. 5A to FIG. 7B. FIG. 5A to FIG. 7B illustrate different embodiments of indication information displayed on the display interface of the electronic device respectively. It should be noted that the embodiments of FIG. 5A, FIG. 6A and FIG. 7A show that the indication information includes black horizontal arrows for indicating horizontal and vertical movement directions from the electronic device 10 toward the unmanned aerial vehicle UAV at the same time, and the embodiments of FIG. 5B, FIG. 6B and FIG. 7B show that the indication information includes a black point indicator for indicating a real-time location of the unmanned aerial vehicle UAV and indicating horizontal and vertical movement directions from the electronic device 10 toward the unmanned aerial vehicle UAV at the same time, but not limited to this.

As shown in FIG. 5A, the indication information displayed on the display interface 5 of the electronic device 10 includes a black horizontal arrow indicating that the horizontal movement direction from the second horizontal angle (145°) of the electronic device 10 in the space SP toward the first horizontal angle (166°) of the unmanned aerial vehicle UAV in the space SP is to move rightward, and the indication information also includes a black vertical arrow indicating that the vertical movement direction from the second vertical angle (13°) from the electronic device 10 in the space SP to the first vertical angle (24°) of the unmanned aerial vehicle UAV in the space SP is to move upward. Thereby, the user can move the UAV jammer 12 rightward and upward to adjust the launch angle of the UAV jammer 12 to aim at the unmanned aerial vehicle UAV, but not limited to this.

As shown in FIG. 5B, the indication information displayed on the display interface 5 of the electronic device 10 includes a black point indicator indicating that the unmanned aerial vehicle UAV is in the upper right direction of the electronic device 10, so that the UAV jammer 12 should be moved rightward and upward to adjust the launch angle of the UAV jammer 12 to target the unmanned aerial vehicle UAV, but not limited to this.

As shown in FIG. 6A, since the second horizontal angle (166°) of the electronic device 10 in the space SP is equal to the first horizontal angle (166°) of the unmanned aerial vehicle UAV in the space SP, it represents that the launch angle of the UAV jammer 12 no longer needs to be moved in the horizontal direction. The indication information displayed on the display interface 6 of the electronic device 10 includes a black vertical arrow indicating that the vertical movement direction from the second vertical angle (35°) of the electronic device 10 in the space SP toward the first vertical angle (24°) of the unmanned aerial vehicle UAV in the space SP is to move downward. Thereby, the user can move the UAV jammer 12 downward to adjust the launch angle of the UAV jammer 12 to target the UAV, but not limited to this.

As shown in FIG. 6B, the indication information displayed on the display interface 6 of the electronic device 10 includes a black point indicator indicating that the unmanned aerial vehicle UAV is in the downward direction of the electronic device 10, so that the UAV jammer 12 should be moved downward to adjust the launch angle of the UAV jammer 12 to target the unmanned aerial vehicle UAV, but not limited to this.

As shown in FIG. 7A, since the second horizontal angle (166°) of the electronic device 10 in the space SP is equal to the first horizontal angle (166°) of the unmanned aerial vehicle UAV in the space SP and the second vertical angle (24) of the electronic device 10 in the space SP is equal to the first vertical angle (24°) of the unmanned aerial vehicle UAV in the space SP, it represents that the launch angle of the UAV jammer 12 no longer needs to be moved in both horizontal and vertical directions, so the indication information displayed on the display interface 7 of the electronic device 10 includes a black circle located in the center of each arrow to indicate that the launch angle of the UAV jammer 12 has been aimed at the unmanned aerial vehicle UAV without moving anymore, but not limited to this.

As shown in FIG. 7B, the indication information displayed on the display interface 7 of the electronic device 10 includes a black point indicator indicating that the launch angle of the UAV jammer 12 has been aimed at the unmanned aerial vehicle UAV without moving anymore, but not limited to this.

It should be noted that the display interfaces of the electronic device shown in FIG. 5A to FIG. 7B are only some embodiments of the invention. In fact, other different display interfaces can be used according to practical requirements without specific limitations.

In practical applications, the electronic device can also load and display an electronic map and mark coordinate values of one or more UAVs and the electronic device on the electronic map based on the position information of one or more UAVs and the position information of the electronic device, but not limited to this. In addition, the electronic device can also calculate the optimal paths between the electronic device and different UAVs based on the position information of the one or more UAVs and the position information of the electronic device respectively, and mark them on the electronic map, but not limited to this.

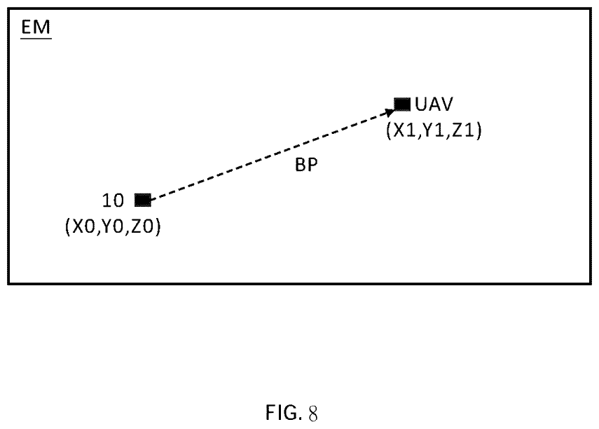

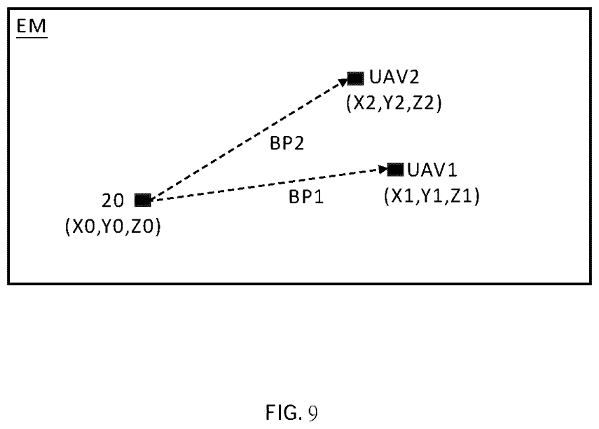

Please refer to FIG. 8 to FIG. 9. FIG. 8 to FIG. 9 illustrate different embodiments of electronic maps displayed by an electronic device respectively.

As shown in FIG. 8, corresponding to the embodiment in which there is only a single unmanned aerial vehicle UAV in the space SP shown in FIG. 1 to FIG. 2, the electronic device 10 can load and display the electronic map EM and can mark the coordinate value (X0, Y0, Z0) of the electronic device 10 and the coordinate value (X1, Y1, Z1) of the unmanned aerial vehicle UAV, as well as the optimal path between the electronic device 10 and the unmanned aerial vehicle UAV on the electronic map EM, for users'reference when operating the UAV jammer 12 to target the unmanned aerial vehicle UAV.

As shown in FIG. 9, corresponding to the embodiment in which there are a plurality of unmanned aerial vehicles UAV1˜UAV2 in the space SP shown in FIG. 3 to FIG. 4, the electronic device 30 can load and display the electronic map EM and can mark the coordinate value (X0, Y0, Z0) of the electronic device 30, the coordinate value (X1, Y1, Z1) of the first unmanned aerial vehicle UAV1 and the coordinate value (X2, Y2, Z2) of the second unmanned aerial vehicle UAV2 on the electronic map EM. In addition, the electronic map EM can also mark the first optimal path BP1 between the electronic device 30 and the first unmanned aerial vehicle UAV1 and/or the second optimal path BP2 between the electronic device 30 and the second unmanned aerial vehicle UAV2, for users'reference when operating the UAV jammer 12 to target the first unmanned aerial vehicle UAV1 or the second unmanned aerial vehicle UAV2.

From the above, it can be seen that the display interface of the electronic device of the invention can display the electronic map and mark the indication information such as the position information of one or more UAVs in the space and the optimal path from the electronic device to the one or more UAVs on the electronic map, but not limited to this.

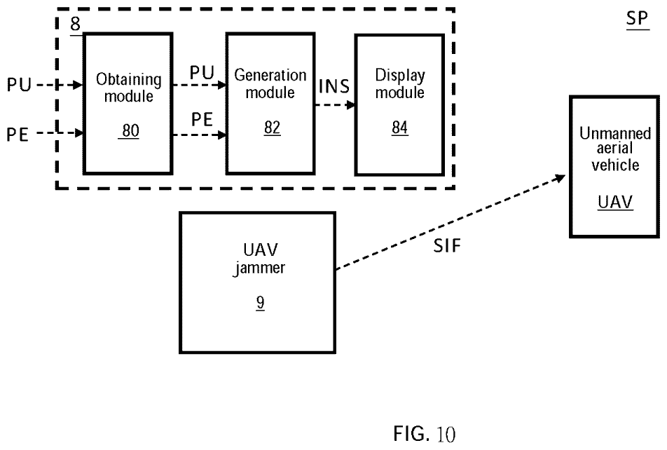

Another embodiment of the invention is an electronic device with a UAV interference indication function. As shown in FIG. 10, the electronic device 8 includes an obtaining module 80, a generation module 82 and a display module 84. The generation module 82 is coupled to the obtaining module 80. The display module 84 is coupled to the generation module 82. The obtaining module 80 is configured to respectively obtain a first position information PU related to the unmanned aerial vehicle UAV in a space SP and a second position information PE related to the electronic device 8 in the space SP. The generation module 82 is configured to generate an indication information INS according to the first position information PU and the second position information PE. The display module 84 is configured to display the indication information INS, in which a state of the UAV jammer 9 disposed corresponding to the electronic device 8 is adjusted according to the indication information INS, so that the UAV jammer 9 can selectively emit an interference signal SIF.

In practical applications, the electronic device 8 can also include a processing module (not shown in the figures), which is coupled to the obtaining module 80 and the display module 84 respectively, configured to load the electronic map and mark the positions of the unmanned aerial vehicle UAV and the electronic device 8 on the electronic map based on the first position information PU and the second position information PE and then provided to the display module 84 for display, but not limited to this. In addition, the processing module can also calculate the optimal path between the unmanned aerial vehicle UAV and the electronic device 8 based on the first position information PU and the second position information PE and mark the optimal path on the electronic map, but not limited to this.

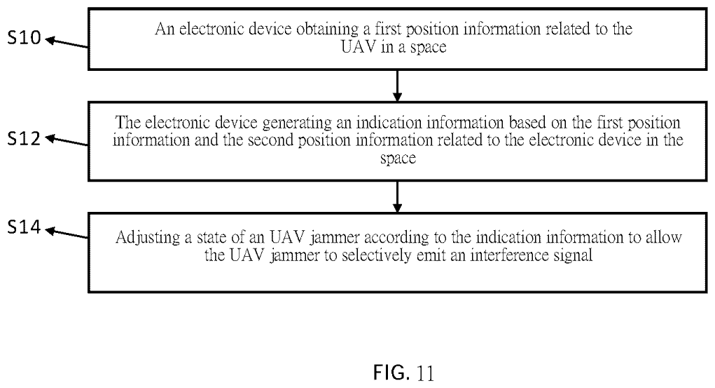

In another embodiment, as shown in FIG. 11, an UAV interference method applied to the UAV interference system of the invention can include steps of:
Step S10: an electronic device obtaining a first position information related to the UAV in a space;
Step S12: the electronic device generating an indication information based on the first position information and the second position information related to the electronic device in the space; and
Step S14: adjusting a state of an UAV jammer according to the indication information to allow the UAV jammer to selectively emit an interference signal.

Compared with the prior art, the invention proposes an UAV interference system and an electronic device with an UAV interference indication function, which can effectively generate the indication information based on the position information of one or more UAVs to guide the user to correctly operate and adjust the state of the UAV jammer. Even if the UAV is too far away and flying too fast or affected by external environmental factors such as sunlight, rain, wind and sand, the user can still smoothly operate the UAV jammer according to the instruction information provided by the electronic device to accurately emit the interference signal to the UAV to successfully complete the task of jamming the UAV.

The contents disclosed above are merely feasible embodiments of the invention, and are not intended to limit the scope of the claims of the invention. Therefore, all equivalent technical changes made based on the specification and the drawings of the invention fall within the scope of the claims of the invention.

What is claimed is:

1. An unmanned aerial vehicle (UAV) interference system, comprising:
an electronic device configured to:
obtain first position information of a UAV in a three-dimensional space; and
generate indication information based on the first position information and second position information of the electronic device; and
an UAV jammer operatively associated with the electronic device, wherein the UAV jammer is configured to adjust its operational state based on the indication information and selectively emit an interference signal toward the UAV.

2. The UAV interference system according to claim 1, wherein the first position information comprises at least a coordinate value, a horizontal angle, and a vertical angle of the UAV, and the second position information comprises a coordinate value, a horizontal angle, and a vertical angle of the electronic device.

3. The UAV interference system according to claim 1, wherein the indication information comprises:
a relative distance derived from the first and second coordinate values,
horizontal angle adjustment information derived from the first and second horizontal angles, and
vertical angle adjustment information derived from the first and second vertical angles.

4. The UAV interference system according to claim 3, wherein the indication information further comprises one or more indicators for:
identifying the real-time location of the UAV, and
specifying horizontal and vertical movement directions required to align the UAV jammer with the UAV.

5. The UAV interference system according to claim 1, wherein the operational state of the UAV jammer comprises a launch angle, and the launch angle is dynamically adjusted to target the UAV based on the indication information.

6. The UAV interference system according to claim 1, wherein the electronic device is further configured to:
display an electronic map illustrating the locations of the UAV and the electronic device based on the position information.

7. The UAV interference system according to claim 6, wherein the electronic device calculates an optimal trajectory between the UAV and the electronic device and marks the trajectory on the electronic map.

8. The UAV interference system according to claim 1, wherein the electronic device is physically integrated with the UAV jammer or mounted on a bracket operatively associated with the UAV jammer.

9. The UAV interference system according to claim 1, wherein the electronic device is a mobile device selected from a group consisting of a mobile phone, a tablet computer, or a personal digital assistant (PDA).

10. An electronic device with an unmanned aerial vehicle (UAV) interference indication function, comprising:
an obtaining module, configured to obtain first position information of a UAV in a three-dimensional space and second position information of the electronic device;
a generation module, coupled to the obtaining module, configured to generate indication information based on the first position information and the second position information; and
a display module, coupled to the generation module, configured to display the indication information, wherein an operational state of an UAV jammer operatively associated with the electronic device is adjusted based on the indication information and the UAV jammer selectively emits an interference signal toward the UAV.

11. The electronic device according to claim 10, wherein the first position information comprises at least a coordinate value, a horizontal angle, and a vertical angle of the UAV, and the second position information comprises a coordinate value, a horizontal angle, and a vertical angle of the electronic device.

12. The electronic device according to claim 10, wherein the indication information comprises:
a relative distance derived from the first and second coordinate values;
horizontal angle adjustment information derived from the first and second horizontal angles; and
vertical angle adjustment information derived from the first and second vertical angles.

13. The electronic device according to claim 12, wherein the indication information further comprises one or more indicators for:
identifying the real-time location of the UAV, and
specifying horizontal and vertical movement directions required to align the UAV jammer with the UAV.

14. The electronic device according to claim 10, wherein the operational state of the UAV jammer comprises a launch angle, and the launch angle is dynamically adjusted to target the UAV based on the indication information.

15. The electronic device according to claim 10, wherein the electronic device is further configured to:
display an electronic map illustrating the locations of the UAV and the electronic device based on the position information.

16. The electronic device according to claim 15, wherein the electronic device calculates an optimal trajectory between the UAV and the electronic device and marks the trajectory on the electronic map.

17. The electronic device according to claim 10, wherein the electronic device is physically integrated with the UAV jammer or mounted on a bracket operatively associated with the UAV jammer.

18. The electronic device according to claim 10, wherein the electronic device is a mobile device selected from a group consisting of a mobile phone, a tablet computer, or a personal digital assistant (PDA).

19. An unmanned aerial vehicle (UAV) interference method, applied to an UAV interference system comprising an electronic device and an UAV jammer, the UAV jammer being operatively associated with the electronic device, the UAV interference method comprising steps of:
the electronic device obtaining first position information of a UAV in a three-dimensional space;
the electronic device generating an indication information based on the first position information and second position information of the electronic device; and
the UAV jammer adjusting its operational state based on the indication information and selectively emit an interference signal toward the UAV.

20. The UAV interference method according to claim 19, wherein the first position information comprises at least a coordinate value, a horizontal angle, and a vertical angle of the UAV, and the second position information comprises a coordinate value, a horizontal angle, and a vertical angle of the electronic device.
